(19) United States
(12) Patent Application Publication
(10) Pub. No.: US 2025/0235825 A1
(43) Pub. Date: Jul. 24, 2025

(54) SYSTEMS AND METHODS FOR OSMOTICALLY ASSISTED REVERSE OSMOSIS CONFIGURATIONS

(71) Applicant: MASSACHUSETTS INSTITUTE OF TECHNOLOGY, Cambridge, MA (US)

(72) Inventors: John H. LIENHARD, Lexington, MA (US); Andrew T. BOUMA, Cambridge, MA (US)

(21) Appl. No.: 18/833,448

(22) PCT Filed: Apr. 21, 2023
(86) PCT No.: PCT/US2023/019400

§ 371 Date: Jul. 26, 2024

Related U.S. Application Data
(60) Provisional application No. 63/333,489, filed on Apr. 21, 2022.

(51) Int. Cl. B01D 61/06; B01D 61/02

(52) U.S. Cl. CPC B01D 61/06; B01D 61/026; B01D 2311/2512; B01D 2313/246; B01D 2317/022

(57) ABSTRACT

Systems and methods for desalinating a liquid feed using a membrane-based fluid filtration system are disclosed herein. The desalination system of the present embodiments can include a first osmotically assisted reverse osmosis (OARO) unit in fluid communication with a second OARO unit for desalination and brine concentration of a liquid feed into the first OARO unit. The concentrate product from the first OARO unit can be split into a first stream and a second stream, with the first stream entering the concentrate side of the second OARO unit and the second stream entering the diluate side of the second OARO unit. Additionally, or alternatively, the diluate product of the second OARO unit can be further split between inlets of the first and second OARO units. In some embodiments, the OARO units can be in fluid communication with a reverse osmosis (RO) unit to receive a RO concentrate feed therethrough.

### CROSS REFERENCE TO RELATED APPLICATION

The present disclosure claims priority to and the benefit of U.S. Provisional Application No. 63/333,489, entitled “Osmotically Assisted Reverse Osmosis Configuration” filed on Apr. 21, 2022, the content of which is incorporated by reference herein in its entirety.

### FIELD

The present disclosure relates to systems and methods for brine concentration technologies, and more particularly relates to novel systems and methods for osmotically assisted reverse osmosis configurations that achieve improved salinity of liquid feeds.

### BACKGROUND

Membrane-based brine concentration systems have seen increased interest in the past decade for a number of reasons. First, increases in the costs of disposing of brine or wastewater have driven the search for systems to reduce brine volumes. Alternatively, or additionally, concentrating brines can allow for the extraction of minerals and other by-products from resource-rich feedwaters. Cost-effective and efficient brine concentration is important for many industries and processes including seawater and brackish water desalination, treatment of produced water, pulp and paper, dairy products, and mining. Conventional techniques can use advanced brine concentration systems to address challenges such as carbon capture and storage and mineral recovery applications, such as extraction of lithium from geothermal brines, nitrate recovery, and others. Due to the volume of feedwater available to a desalination system being limited or difficult to expand, enhanced brine concentration systems may be used to recover additional water from a given feed stream. Finally, the demand for brine concentration systems can also stem from regulatory pressures to protect sensitive environments from brine.

In response to these pressures, a number of different technologies have been invented and developed to complement existing thermal brine concentration technologies within the past few decades. While thermal technologies are more mature and their performance challenges and benefits are well-established, fundamental thermodynamics suggests that membrane-based systems are likely to outperform thermal methods in terms of primary energy consumption. Additionally, work-driven systems may be easier to electrify and de-carbonize than thermal brine concentration technologies, driving interest in membrane-based systems in a variety of areas.

Membrane separations may have inherent advantages compared to evaporative separations due to costs of materials and the permeability of those materials. To date, while membrane separation processes such as reverse osmosis (RO) have surpassed other thermal desalination technologies as the primary unit operation in most desalination systems, RO continues to have several shortcomings. For example, RO has significant recovery limitations at high salinities, which results in excessive waste after operation. Ultra-high-pressure RO (UHPRO) has been explored as a solution to this problem, but the more extreme operating conditions and pressures involved in UHPRO increases the need for upgraded pumps, pipes, etc., thereby driving up system costs in an undesirable and unsustainable manner.

At present, there is still a need for improved brine concentration technologies that operate efficiently between the useful operating ranges of RO and crystallizers (e.g., ˜70-200 g/kg). Existing technologies in this range include multiple effect distillation (MED), multi-stage flash (MSF), and mechanical vapor compression (MVC). These technologies, however, while robust, tend to be high in cost and low on energy efficiency. Osmotically assisted reverse osmosis (OARO) and low-salt rejecting reverse osmosis (LSRRO) are two membrane-based brine concentration technologies that compete with UHPRO, and operate at lower hydraulic pressures. LSRRO and OARO, while demonstrating potential to outperform evaporative technologies in terms of energy consumption and total water cost, as well as when used with thermo-responsive draw solutions, are still in development and determination of optimization parameters for these technologies has so far been inconclusive.

Accordingly, improved systems and methods are needed for improved systems and methods for desalinating a liquid feed while maximizing a recovery ratio of the product stream.

### SUMMARY

The present application is directed to systems and methods for osmotically assisted reverse osmosis configurations that achieve improved salinity of liquid feeds. The systems and methods disclosed utilize a combination of brine-split and feed-split configurations fed through OARO modules arranged in series to reduce salinity of a liquid feed passed through the system. A stream that exits a first OARO unit can be split into two streams, with one stream entering a concentrate side of a second OARO unit, and the other stream entering a diluate side of the second OARO unit in a depressurized state. The diluate product from the second OARO unit can enter the diluate side of the first OARO unit, with diluate from the first unit being mixed with a feed into the system. In some embodiments, the feed to the OARO modules can be RO concentrate that passes from an RO module. Moreover, in such embodiments, the diluate product can be split into a stream that can enter the diluate side of the first OARO unit and a rebalance stream that mixes with the RO concentrate stream being fed into the first OARO unit.

One exemplary desalination system includes a first osmotically assisted reverse osmosis (OARO) unit, a second OARO unit in fluid communication with the first OARO unit and a liquid feed. The first OARO unit has a concentrate side with a first inlet and a first outlet and a diluate side with a second inlet and a second outlet, the second OARO unit has a concentrate side with a first inlet and a first outlet and a diluate side with a second inlet and a second outlet, and the liquid feed is received in the first inlet of the first OARO unit. A concentrated stream leaving the first OARO unit is split into a first stream and a second stream, with the first stream entering the first inlet of the second OARO unit and the second stream being depressurized and entering the second inlet of the second OARO unit. A diluate product of the second OARO unit enters the second inlet of the first OARO unit, and a concentrate product exiting the first outlet of the second OARO unit is depressurized and includes an outlet stream having a salinity that is greater than a salinity of the liquid feed.

A relative length of the first OARO unit and a relative length of the second OARO unit can be adjusted to optimize at least one of a flow rate or salinity at the first inlet of the second OARO unit and the second inlet of the second OARO unit to minimize energy consumption. In some embodiments, a fraction of flow split between the first stream and second stream can be adjusted to optimize at least one of a flow rate or salinity at the first inlet of the second OARO unit and the second inlet of the second OARO unit to minimize energy consumption or total membrane area. The salinity of the first outlet of the first OARO unit can be optimized when the salinity at the first outlet of the first OARO unit is fixed to minimize energy consumption. A fraction of the concentrate of the first OARO unit entering the first inlet of the second OARO unit can be optimized when the salinity at the first outlet of the first OARO unit is fixed to minimize energy consumption or total membrane area.

In some embodiments, the system can further include one or more energy recovery devices (ERDs) configured to depressurize one or more of the second stream or the concentrate product. At least one of the first and second OARO units can include one or more hollow fiber membranes. The diluate product of the second OARO unit can be split into a first diluate stream and a second diluate stream, with the first diluate stream entering the second inlet of the first OARO unit and the second diluate stream being pressurized and entering the concentrate side of the first OARO unit. In some embodiments, at least a portion of the diluate product of the second OARO unit can be mixed with the liquid feed prior to passing through the first inlet of the first OARO unit. The first OARO unit and the second OARO unit can be arranged in series.

The desalination system can include a reverse osmosis (RO) unit that is in fluid communication with the first OARO unit, and has a first inlet and a first outlet. The liquid feed can be an RO concentrate stream that can be passed through the RO prior to passing into the first inlet. In some embodiments, the diluate product of the first OARO unit can be mixed with a feed that passes through the first inlet of the RO unit to form the RO concentrate stream. The first OARO unit and the second OARO unit can be arranged in series with the RO unit.

One exemplary method of desalinating fluid includes flowing a liquid feed through a first osmotically assisted reverse osmosis (OARO) unit and a second OARO unit arranged in series with the first OARO unit, splitting a concentrated stream leaving the first OARO unit into a first stream and a second stream. The first OARO unit has a concentrate side with a first inlet and a first outlet and a diluate side with a second inlet and a second outlet, and the second OARO unit has a concentrate side with a first inlet and a first outlet and a diluate side with a second inlet and a second outlet, with the first stream entering the first inlet of the second OARO unit and the second stream being depressurized and entering the second inlet of the second OARO unit. The method also includes flowing a diluate product of the second OARO unit through the second inlet of the first OARO unit; and depressurizing a concentrate product exiting the first outlet of the second OARO unit, a salinity of the concentrate product being greater than a salinity of the liquid feed.

The method can further include splitting the diluate product of the second OARO unit into a first diluate stream and a second diluate stream, the first diluate stream entering the second inlet of the first OARO unit and the second diluate stream being pressurized and entering the concentrate side of the first OARO unit. Adjusting a relative length of the first OARO unit and a relative length of the second OARO can optimize at least one of a flow rate or salinity at the first inlet of the second OARO unit and the second inlet of the second OARO unit to minimize energy consumption or total membrane area. Adjusting a fraction of flow split between the first stream and second stream can optimize at least one of a flow rate or salinity at the first inlet of the second OARO unit and the second inlet of the second OARO unit to minimize energy consumption or total membrane area.

The method can further include mixing the diluate product of the second OARO with the liquid feed prior to flowing the liquid feed through the first inlet of the first OARO unit. In some embodiments, the method can include pumping a liquid feed into an inlet of an RO unit that is in fluid communication with the first OARO unit to form a product concentrate stream that is fed into the inlet of the first OARO unit. In some embodiments, the method can include operating one or more ERDs to depressurize one or more of the second stream or the concentrate product.

### BRIEF DESCRIPTION OF THE DRAWINGS

This disclosure will be more fully understood from the following detailed description taken in conjunction with the accompanying drawings, in which:

FIG. 1A is a schematic diagram of a prior art osmotically assisted reverse osmosis (OARO) basic unit;

FIG. 1B is a schematic diagram of a prior art reverse osmosis (RO) basic unit;

FIG. 1C is a schematic diagram of a prior art forward osmosis (FO) basic unit;

FIG. 1D is a schematic diagram of a prior art low salt rejection reverse osmosis (LSRRO) basic unit;

FIG. 2 is a schematic illustration of a prior art crossflow mixing in the basic units of FIGS. 1B-1D;

FIG. 3A is a schematic diagram of a prior art one-stage split-feed OARO system;

FIG. 3B is a schematic diagram of a prior art two-stage split-feed OARO system;

FIG. 4A is a schematic diagram of a prior art one-stage LSRRO system;

FIG. 4B is a schematic diagram of a prior art two-stage LSRRO system;

FIG. 5 is a schematic diagram of a prior art split-brine OARO system;

FIG. 6A is a schematic diagram of one embodiment of a semi-split OARO system of the present embodiments;

FIG. 6B is a schematic diagram of a one embodiment of a semi-split OARO system of the present embodiments having a rebalance stream;

FIG. 7A is a graph illustrating impacts of changes in flow ratio on a total membrane area and specific energy consumption of the semi-split OARO system of FIG. 6A;

FIG. 7B is a graph illustrating lengths of OARO stages of the semi-split OARO system of FIG. 6A relative to system outlet concentration to minimize energy consumption; and

FIG. 8 is a schematic diagram of one exemplary embodiment of a computer system upon which the control system of the present disclosures can be built.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, compositions, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Like-numbered components across embodiments generally have similar features and/or serve similar purposes unless otherwise stated or a person skilled in the art would appreciate differences based on the present disclosure and/or his/her knowledge. Accordingly, aspects and features of every embodiment may not be described with respect to each embodiment, but those aspects and features are applicable to the various embodiments unless statements or understandings are to the contrary.

To the extent that the present disclosure includes various terms for components and/or processes of the disclosed systems, methods, and the like, one skilled in the art, in view of the claims, present disclosure, and knowledge of the skilled person, will understand such terms are merely examples of such components and/or processes, and other components, designs, processes, and/or actions are possible. By way of non-limiting example, a person skilled in the art will recognize various terms that are used herein interchangeably, such as the terms “flow from,” “flow to,” or “fluid communication” to refer to fluid flowing within the system via conduits that can be responsible for connecting system components and flowing saline fluid and/or liquid feeds throughout the system. Moreover, the terms “unit” or “stage” can be used interchangeably to refer to basic units that include a module, an inlet, an outlet, and streams flowing therethrough, with the number of units or stages referring to the how many of such units exist in the system containing these units. Further, to the extent features, sides, or steps are described as being “first” or “second,” such numerical ordering is generally arbitrary, and thus such numbering can be interchangeable. Lastly, the present disclosure includes some illustrations and descriptions that include prototypes or bench models. A person skilled in the art will recognize how to rely upon the present disclosure to integrate the techniques, systems, devices, and methods provided for into a product, such as an industrial, commercial, and/or home-scale desalination system, a wastewater treatment facility, a mineral recovery system, a pharmaceutical processing plant, among others, in view of the present disclosures.

At least one novel aspect of the present disclosure lies in a brine concentration system having a plurality of OARO units with split streams, referred to herein as a “semi-split OARO system.” The semi-split OARO system can include a plurality of OARO units that are in fluid communication with one another with streams that split to separate concentrate and diluate as feeds respective concentrate and diluate sides of the respective OARO units. Fluid communication between units can be formed via one or more conduits, such as pipes or tubing, valves, and other features that can pass fluid from one component to another that would be appreciated by one skilled in the art. With the respective split-streams, the semi-split OARO system can improve on salinity performance with respect to prior art split-feed and split-brine OARO configurations, while also increasing operating range, energy consumption, and membrane area as compared to brine concentration technologies, specifically low-salt rejection reverse osmosis (LSRRO) and osmotically assisted reverse osmosis (OARO), which are discussed in greater detail below. The OARO units of the semi-split OARO system can include hollow fiber membranes to desalinate the feed and/or concentrate the brine. One or more features of the semi-split OARO system can be adjusted to optimize flow rate and/or salinity at the outlets of the first and second OARO units, which can optimize the salinity concentration of the outlet of the second OARO unit when the outlet salinity is fixed.

### OVERVIEW OF OARO

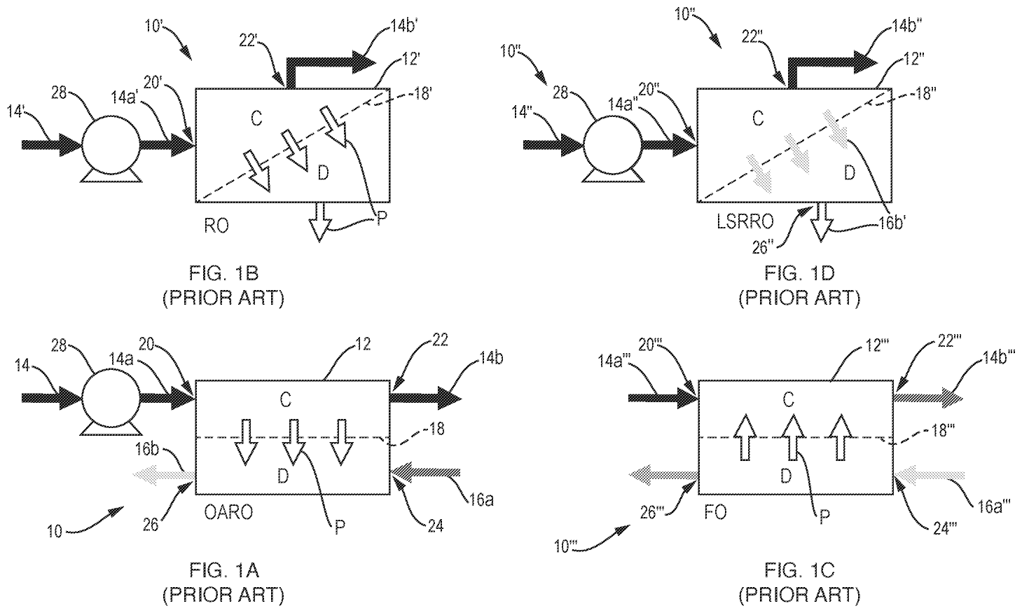

FIG. 1A illustrates a prior art example of an osmotically assisted reverse osmosis basic unit or unit 10. As shown, the basic unit 10 includes a module 12 with saline streams 14a, 16a, flowing on both sides of a semi-permeable membrane 18 in a counterflow configuration, with permeate P flowing from the first stream 14a to the second stream 16a. The module 12 can be divided in a concentrate side C and a diluate side D, with permeate P flowing from the concentrate side C to the diluate side D. As shown, the first stream 14a can be located at the concentrate side C having a higher concentration, pressurized stream and the second stream 16a can be located at the diluate side D having a lower-concentration, low-pressure stream. The first stream 14a can flow into an inlet 20 of the module 12 and flow out of an outlet 22 of the module after permeate has been extracted therefrom, with the stream 14b at the outlet 22 being a product stream that is more concentrated than the first stream 14a at the inlet 20. Similarly, the second stream 16a can flow into an inlet 24 of the module 12 and flow out of an outlet 26 of the module 12 after receiving the permeate P therein, with the stream 16b at the outlet 26 being a diluate stream that is less concentrated than the stream 16a at the inlet 24. A pump 28 can optionally be used to pump the first stream 14 into the module 12.

FIGS. 1B-1D illustrate standard reverse osmosis (RO), forward osmosis (FO), and LSRRO, respectively, with a person skilled in the art recognizing that like-numbered components across embodiments generally have similar features unless otherwise stated and/or is otherwise known to operate or behave in a different manner because of the way typical RO, FO, and LSRRO processes work. The units shown in FIGS. 1A-1D are traditionally assumed to utilize membranes that can be approximated for modeling purposes as fully dense. Thus, there is assumed to be minimal or no pore flow through the membranes, and the solution-diffusion model can be used to model water and salt transport through the active layer of the membrane according to Eq. 1 and Eq. 2:

$$Jw = A ( Δ P - Δπ ) \qquad ( Eq . 1 )$$

$$Js = B Δ C \qquad ( Eq . 2 )$$

Here, Jw and Js refer to water flux and salt flux, respectively, P is hydraulic pressure, π is osmotic pressure, C is concentration, and A refers to a differential between these quantities across the active layer of the membrane. A and B refer to water and salt permeability, often given in units of liters/m²-hour-bar (LMH-bar) and liters/m²-hour (LMH), respectively. One having ordinary skill in the art will recognize that the basic OARO unit 10 can be configured and staged in a number of ways, which has led to a number of different names for the technology, although all are based on the same basic unit, such as counterflow reverse osmosis (CFRO), cascading osmotically mediated reverse osmosis (COMRO), osmotically enhanced dewatering-reverse osmosis (OED-RO), and draw solution assisted reverse osmosis (DSARO).

For example, FIGS. 1B and 1C illustrate reverse osmosis (RO) and forward osmosis (FO) units, respectively. As shown, the RO unit 10′ includes a module 12′ having a single feed stream 14a′ flowing, or pumped via pump 28, through an inlet 20′ thereof into the concentrate side C. Permeate P flows across the membrane 18′ from the concentrate side C to the diluate side D with a product stream 14b′ exiting from an outlet 22′ of the concentrate side C. As shown, the membrane 18′ is oriented at an angle within the module 12′ to separate the concentrate side C from the diluate side D, unlike the membrane orientation 18 in the OARO module 12 due to the presence of a single inlet stream in the module 12′. The RO and LSRRO units 10′, 10″ of FIGS. 1B and 1D are three-port units with one inlet and two outlets, while the OARO and FO units 10, 10″ of FIGS. 1A and 1C are “four-port” devices, with two inlet ports and two outlet ports. At the concentrate/feed inlet (left side) of the three-port devices 20′, 20″, there may be little to no flow. As we move from left to right in those units 10′, 10″, the cumulative permeate flow grows, while the concentrate flows shrink. The four-port units, on the other hand, have substantial flows at all points within the modules 12, 12′″, with the membranes 18, 18′″ being oriented in a horizontal orientation. The product stream 14b′ is more concentrated than the feed stream 14b′ that enters the inlet 20′. In forward osmosis, shown in FIG. 1C, two inlet streams 14a′″ and 16a′″ enter inlets 20″ and 24″ in the concentrate side C and the diluate side D, respectively, with permeate P passing from the diluate side D to the permeate side C across the membrane 18′″. Two product streams 14b′″ and 16b′″ exit the module 12′″ via outlets 22″ and 26″, respectively, with product stream 14b″″ being more concentrated than the product stream 16b′ “.

FIG. 1D, in particular, illustrates a prior art example of an LSRRO unit or stage 10”, with the terms “unit” and “stage” being able to be used interchangeably, as noted above. It will also be appreciated that the terms “unit” and “system” can be used interchangeably when the system is composed of a single unit, as in FIGS. 1A-1D, As shown, a module 12″ of the LSRRO unit 10″ can operate by using a hydraulic pressure differential exerted by the pump 28 to drive permeate P through a membrane 18″. In some embodiments, one pump can be used to drive two stages (i.e. high pressure from a first stage flows into a second stage, still at high pressure, without an additional pump for each stage). As shown, the membrane 18″ is oriented at an angle within the module 12″ to split the concentrate side C from the diluate side for reasons similar to those discussed above with respect to FIG. 1B. The feed side stream 14a″ is concentrated, and a diluate or saline permeate stream 16b″ exits the permeate side, or diluate side D, of the membrane 18″ and out of the module 12″ via outlet 26″. The saline permeate stream 16b″ has an elevated osmotic pressure compared to pure water that would be on a permeate side in a conventional reverse osmosis system, thus either increasing the water flux or reducing the hydraulic pressure required to maintain a similar flux, according to Eq. (1). Due to the increased osmotic pressure on the permeate side D of the membrane 18″, the LSRRO unit 10″ can maintain flux through the membrane 18″ even at osmotic pressures greater than the applied hydraulic pressure.

The OARO and LSRRO units 10 and 10″ exhibit several similarities. For example, both the OARO and LSRRO units 10 and 10″ can include a potential to reduce the energy consumption and/or cost of brine concentration. Moreover, both can utilize semi-permeable membranes to separate a feed stream 14 into one concentrated stream 14a and one diluate stream 16a. Multiple membrane stages can be arranged in various cascaded configurations to produce increasingly concentrated or diluted product streams. Additionally, either unit 10 or 10″ can produce concentrated or diluted streams at any range of salinities from near pure water to saturation (or beyond).

One having ordinary skill in the art will appreciate that OARO and LSRRO units 10 and 10″ operate differently in several key respects, despite having a number of features in common. For example, the two technologies differ in the number of inlet and outlet streams in a single module, as discussed above. First, the basic OARO unit 10 can have a split-feed configuration in which a feed stream enters the module 12 from the concentrate side C as well as the diluate side D. For example, as shown in FIG. 1A, in the OARO unit 10, the saline stream 16a on the diluate side D of the membrane 18 is introduced directly to the system via the inlet 24, and the permeate, e.g., water, permeates from the concentrate stream 14 to the diluate stream 16 while the product stream 14b, e.g., salt, is rejected. That is, there are four streams in a single OARO module 12: two inlet points 20, 24 and two outlet points 22, 26, with a concentrate-side feed stream 14a and product stream 14b, and a diluate-side feed stream 16a and product stream 16b.

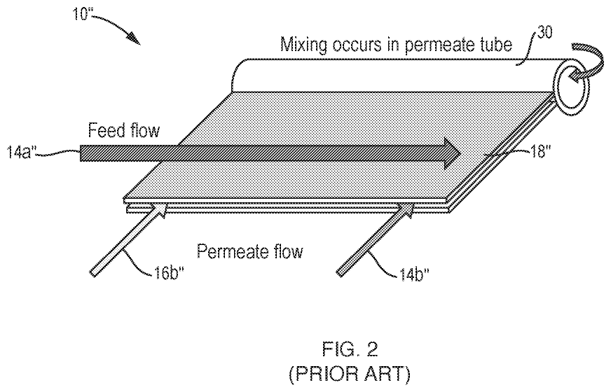

The LSRRO module 12″, on the other hand, includes three streams: a single feed stream 14a″, a concentrate-side product stream 14b″, and a diluate-side product stream 16b″, with both the salt and water portions of the diluate-side product stream 16b″ passing through the membrane 18″, which prevents the membrane 18″ from being perfectly salt rejecting, which contributes to the low-salt rejection of the LSRRO system. The difference in number of inlet and outlet streams corresponds with differences in flow paths, with the OARO unit 10 operating in counterflow, as discussed above, while the LSRRO unit 10″ operates in crossflow, as shown in FIG. 2, with the diluted product being collected in a permeate tube 30.

One skilled in the art will recognize that a benefit of the crossflow operation of the LSRRO unit 10″ is the potential to eliminate the detrimental effects of internal concentration polarization (ICP). For example, under crossflow operation, and assuming no diffusion or convection in the permeate channel in the direction of feed flow, the salinity of the permeate at the membrane surface can be equal to the salinity of the bulk solution. Regardless of the thickness or geometry of the support layer, there is no, or virtually no, concentration difference across the support layer, and therefore no ICP, eliminating a major source of losses and flux reduction that exists in OARO systems (as well as FO and pressure reverse osmosis (PRO) systems).

The geometric differences between the OARO and LSRRO units 10 and 10″ lead to operational and design differences. Due to the three stream design of the LSRRO unit 10″, the salt on the permeate side of the membrane 18″ arrives by passing through the membrane 18″ itself, and the unit 10″ utilizes a membrane(s) 18″ with non-zero salt permeability. Additionally, because of the crossflow operation, water and/or salt can be assumed to flow towards a permeate tube 30 for mixing with no flow thereof in the lateral direction, as shown in FIG. 2. In view of this assumption, the net salinity of the solution passing through the membrane 18″ at each point along the length of the LSRRO unit 10″ should theoretically reach some equilibrium point, and this salinity should be constant through the thickness of the support layer and the bulk solution as it flows towards the permeate tube 30. As a result, there can be no internal concentration polarization (ICP), which can eliminate a major source of losses and flux reduction in the OARO unit 10 (as well as the FO and RO units 10′″ and 10′, respectively).

The three-stream geometry of the LSRRO unit 10″, with a single feedstream 14a″, allows for a wide variety of membrane geometries and a likely simpler membrane development path. Existing widely-produced membrane form factors such as spiral-wound membranes, disc tube RO systems, and more can be adapted to LSRRO operation by a person skilled in the art by adjusting membrane parameters such as water and salt permeability. While OARO, FO, and RO systems all attempt to maintain a relatively low salt permeability and are usually limited by the structural parameter of a membrane in which ICP takes place, purpose-built LSRRO membranes are likely to have high salt permeability and very high water permeability, with the structural parameter theoretically not affecting performance. This can, in theory, allow for very high pressures to be used without worrying about the consequences of increased thicknesses required for structural integrity. Moreover, this improvement may allow for greatly improved fluxes compared to existing OARO systems, which have a two-sided feed operation, with modified hollow fiber systems thereof being the most viable form factor. In fact, this two-sided feed operation is likely to be marked by higher drag, challenges with balancing and eliminating dead spots in spiral wound membranes, and complications with cleaning and fouling behavior for challenging brines. A person skilled in the art will recognize that while OARO systems have to deal with additional concerns around structural parameters and drag on the permeate side, these issues are likely irrelevant for LSRRO systems.

Each of LSRRO and OARO systems can include a variety of technology configurations, including single and multi-staged systems, which can be designed for both minimal energy consumption and minimum system size, resulting in a design envelope that contains all cost-optimal designs. Optimization of the LSRRO and OARO systems can be simulated using realistic form factors and using probability membrane parameters. LSRRO systems conventionally have smaller system sizes than OARO systems, although specific membranes typically determine whether this translates to cost benefits. A detailed discussion of the systems and optimizations thereof continues below.

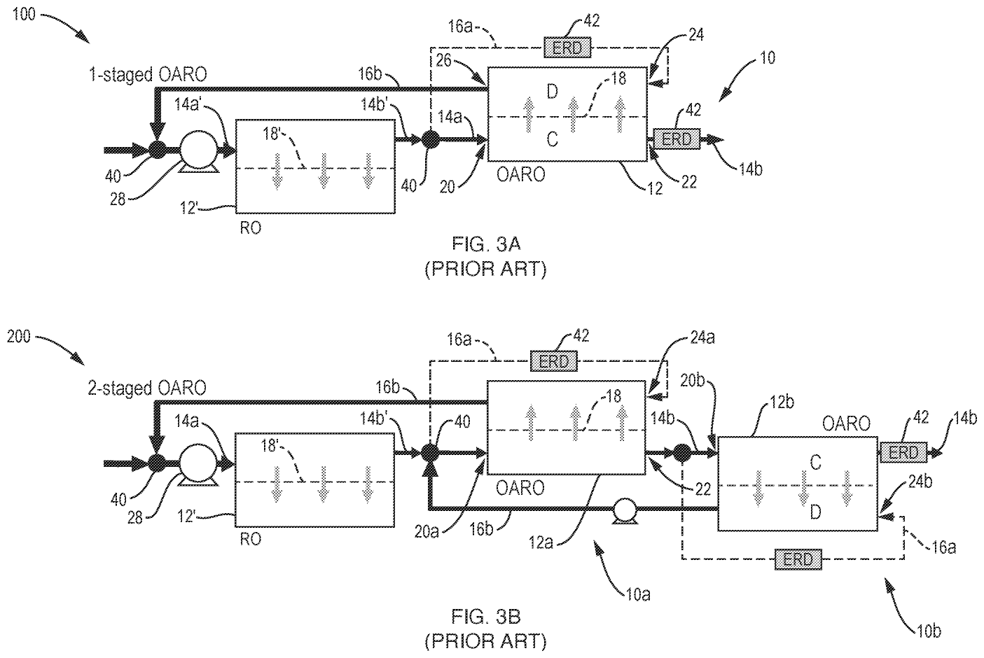

The modules 12, 12′, 12″, 12″ of FIGS. 1A-1D can be arranged in various configurations, e.g., split-feed or split-brine, to customize and/or optimize product stream conditions. FIGS. 3A-3B illustrate a prior art example of a single-stage, or one-stage, split-feed OARO system 100 and a two-stage split-feed OARO system 200, respectively. It will be appreciated that split-feed systems are a type of configuration of the modules 12, 12′, 12″, 12″ in which one or more feeds or streams are split into a plurality of flows. As shown, each of the one-stage OARO system 100 and the two-stage split-feed OARO system 200 can include one or more split points or junctions 40 where a stream can split to be delivered into a plurality of inlets of the same module, another module(s), and/or combined with another stream(s).

For example, the OARO module 12 can be in fluid communication with the RO module 12′ such that the RO concentrate stream 14b′ can be split into two streams, as discussed above, with one being sent to the concentrate side C of the OARO unit 10, while the other is sent to the diluate side D. The diluate-side feed stream 16a may be de-pressurized in an energy recovery device (ERD) 42, as shown, and the recovered pressure can be mixed with the RO feed stream 14a′ to pressurize a portion of the RO feed stream 14a′. The product stream 14b leaving the concentrate side C of the OARO module 12 can flow through the ERD 42 before exiting the system 100, while the rest of the RO stream can use a normal high pressure pump 28. Due to the diluate-side feed stream 24 of the OARO having a fixed maximum salinity (e.g., 70 g/kg), and the maximum hydraulic pressure differential can be set at a fixed pressure (e.g., 70 bar), there is a maximum osmotic pressure and salinity that can be achieved at the concentrate outlet 22, determined by Eq. (1). For example, when optimizing this system 100, the feed conditions and concentrate outlet salinity can be fixed. With operation of the RO unit 10′ being constrained, the only free variable is the split fraction, which measures the fraction of the flow leaving the RO unit 10′ and entering the OARO unit 10 that goes towards the concentrate feed, as in Eq. (3).

$$Split fraction = \frac{mfeed , concentrate}{mfeed , concentrate + mfeed , permeate} \qquad ( 3 )$$

The split ratio adjusts the thermodynamic balance of the system 100. If too much flow is directed to the permeate or diluate side D, fluxes in the system can be enhanced at the cost of additional pump work, as the additional flow increases the volume pumped through the high pressure pump 28. Directing excess flow to the concentrate side C can also unbalance the system 100, causing the smaller flow on the permeate side D of the membrane 18 to be diluted rapidly, thereby increasing the osmotic pressure difference across the membrane 18 and reducing system flux.

As mentioned above, the basic units can be combined to form multi-stage systems. In the two-stage OARO system 200, as shown in FIG. 3B, the product stream 14b leaving the concentrate side C of the OARO unit 10a can become the feed stream for a second OARO unit 10b rather than passing through an ERD 42. As shown, the product stream 14b leaving the concentrate side C of the first OARO module 12a is split into two streams, with one being sent to the concentrate side C of the second OARO unit 10b via inlet 20b, while the other is sent to the diluate side D through inlet 24b. The diluate-side feed stream 16a can be de-pressurized in the ERD 42, as shown, and the recovered pressure can be used to pressurize a portion of the product stream 14b leaving the concentrate side C of the first OARO module 12a. The product stream 14b leaving the concentrate side C of the second OARO module 12b also flows through the illustrated energy recovery device 42 before exiting the system 200.

The split-feed OARO configuration of systems 100, 200 allows for relatively uniform fluxes and entropy generation within the module, which reduces operating costs. However, each stage of the split-feed OARO configuration uses its own ERD 42, which drives up capital costs. Additionally, there is a limit on the maximum recovery achievable for each stage, as the maximum salinity that can be reached at the concentrate outlet is defined by Eq. (1). In order to achieve very high recoveries, many units or stages 10 may be required, increasing the cost of additional valves, pumps, ERDs, etc.

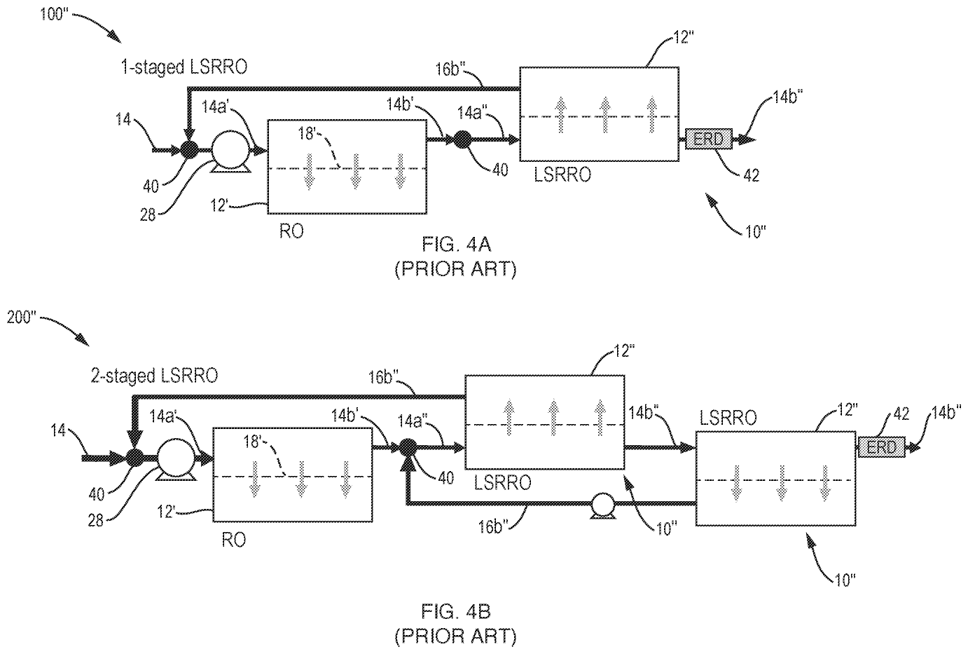

FIGS. 4A-4B illustrate a prior art example of a one-stage split-feed LSRRO system 100′″ and a two-stage split-feed LSRRO system 200″, respectively. As shown, the concentrate product stream 14b″ from the RO unit 10′ can be fed directly into an LSRRO unit 10″. The permeate exits the LSRRO unit 10″ to be recycled and combined with the initial feed stream 14, and the concentrate product stream 14b″ is de-pressurized in the ERD 42. In the single stage system 100″, if the flow rate and salinity entering the stage is determined, the velocity is set, and the outlet concentration is specified, the choices for variables to optimize is small. For example, if membrane salt permeability is chosen to be optimized, which also optimizes the membrane water permeability, then the system is solved to determine the membrane length required to meet the concentrate outlet conditions. It will be appreciated that a very high salt permeability and water permeability will lead to a system that does not reject much salt. In order to achieve high recovery ratios and high brine salinities, large volumes of LSRRO permeate are recirculated, increasing pumping costs and parasitic losses in the pumps. Very low salt permeability and water permeability in the system 100″ will cause very low fluxes, large membrane areas, and parasitic losses due to drag.

In the two-stage split-feed LSRRO system 200″, as shown in FIG. 4B, the concentrate product stream 14b″ from the first LSRRO unit 10″ enters the second LSRRO unit 10″, and the permeate 16b″ from the second unit 10″ is mixed with the RO concentrate 14b″. Similar to the OARO system 200, the additional unit 10″ creates an additional two more variables to optimize, e.g., the membrane salt permeabilities for each of the units 10″ and the inter-stage salinity, for a total of three variables.

Some non-limiting examples of a membrane used with the counterflow operation in the OARO systems 100, 200 can include hollow fiber membranes, e.g., PT26-C, while cross-flow operation in the LSRRO systems 100″, 200″ can use spiral-wound modules. These membranes are likely to perform worse than thin-film composite polyamide membranes on a per-unit-area basis, having thick support layers and lower water permeabilities. However, in the case of OARO systems 100, 200, hollow fiber membranes can pack more membrane area into a given volume, and can cost up to 10 times less than spiral wound membranes on a per-unit-area basis.

### Performance of Single-Stage Systems

A number of insights can be drawn from performance of the single-stage systems. First, at low concentrations, all systems perform similar to RO at low recovery ratios. As the recovery ratio increases, the performance of the various systems diverges. Specifically, at higher concentrations, the OARO systems 100, 200 perform better in terms of energy consumption. Under the conditions used in this analysis (fixed feed conditions and fixed recovery ratio), the amount of salt in the final brine stream may be fixed for a given recovery ratio. Moreover, because the RO system is assumed to completely reject salt, all the salt that enters the single-stage system 100 is rejected in the brine stream. In the OARO system 100, some of the saline feed stream 16a is depressurized and enters the membrane module 12 on the diluate side D. Some of the P-V energy in the saline stream 16a is recovered, albeit inefficiently, in the ERD 42. The permeate P passing through the membrane 18 is of relatively low salinity compared to the LSRRO system, even at high brine concentrations. The saline diluate stream 16b is then passed to be re-pressurized in the RO unit 10′ to reject the salt and extract additional water from the stream. The saline diluate stream 16b, then, recirculates in a loop back to the initial feed stream 14, which modulates the osmotic pressures in the brine concentration systems, thus allowing for reduced hydraulic pressures in the system 100. There are two paths for salt to enter the diluate stream 16 and modulate the osmotic pressure, one being a path through the membrane 18, which functions without energy recovery, and one being a path with direct flow into the diluate stream 16, which allows for energy recovery. Minimizing salt flow through the membrane limits the total amount of useful work required in the membrane modules.

In the LSRRO system 100″ of FIG. 4A, on the other hand, salt is passed through the membrane 18″ to mediate the diluate osmotic pressure, allowing for concentration at high salinities and low hydraulic pressures. All the water and salt that passes through the membrane 18″ does not have any P-V energy recovered in the ERD 42 but passes directly through the membrane 18″. Each bit of salt that passes through the membrane 18″ without being depressurized represents an energy loss, as the energy could have been recaptured in an ERD while the salty stream was placed on the other side of the membrane directly. Thus, at least under the solution-diffusion model that these systems are assumed to operate under, any salt permeation through the membrane represents wasted energy. The spread in performance between systems optimized for energy consumption and systems optimized for membrane area is very small for OARO systems, but much larger for LSRRO systems. For OARO systems, changing the flow ratio by less than about 10 percent can change the system from an energy-optimized system to a size-optimized system. The opposite is true for LSRRO systems, where a size-optimized system maximizes the optimization variable, the membrane salt permeability, while an energy-optimized system has a membrane salt permeability that is in some cases orders of magnitude smaller.

It will be appreciated, as discussed above, that OARO systems elevate the diluate side salinity by introducing a saline stream, and employing a membrane with high salt rejection. This limits the system by the rate of salt diffusion to the membrane active layer against the flow of permeate and through the support layer of the membrane. LSRRO systems elevate the diluate side salinity by employing low-rejection membranes, allowing salt to pass through the membrane much more freely than in OARO systems. This system is limited by the rate of salt diffusion through the membrane active layer itself, as limited rates of salt diffusion through the membrane hinder the increase in permeate-side osmotic pressure, thereby limiting water flux.

Both OARO and LSRRO systems operate similarly, but maintain important distinctions. For example, both systems reduce the osmotic pressure differential across the semipermeable membrane by passing saline solutions on the permeate side of the membrane. This reduced osmotic pressure differential allows for hydraulic pressures to remain in the same range as those used in conventional RO systems, although ultra-high pressures can also be used to drive enhanced recoveries. In both systems, a concentrate stream and a diluate stream are generated. Moreover, these systems can be staged consecutively, as shown in FIGS. 3B and 4B above, to generate solutions of sequentially higher or lower concentrations, giving a theoretical output range of pure water to saturation for any feed stream. Conventionally, these systems can be paired with a reverse osmosis system to generate pure water from the most diluted stream produced in the OARO or LSRRO stages, as discussed above.

The fact that these systems produce a concentrated stream and diluted stream, rather than a concentrated stream and a pure water stream, creates an opportunity for the different design philosophies that make LSRRO and OARO distinct. In the OARO unit 10, the saline permeate stream P is introduced directly into the membrane module 18, which is designed with the concentrate stream 14 and diluate stream 16 in a counterflow configuration. In the LSRRO unit 10″, the saline permeate stream 16b″ is generated by allowing water and salt to flow from the feed stream 14″ through a semi-permeable membrane 18″ that rejects salt at a much lower rate than conventional RO membranes. By allowing the membranes to be “leaky” by design, a variety of different membrane chemistries and form factors may be used. OARO membranes 18, on the other hand, are more limited, as they will likely be required to be in a hollow fiber form factor due to the counterflow nature of the system, and they must reject substantially more salt than LSRRO membranes for the systems to remain effective.

### Performance of Multi-Stage Configurations

Multi-stage systems can outperform single-stage systems in terms of both energy consumption and system area, as additional stages add additional degrees of freedom, allowing for further optimization of flow rates and salinities. Moreover, in multi-stage systems, concentration boundary layers also reset in each new stage, increasing fluxes at stage entrances. Conventionally, however, the benefits of multi-staging at low concentrations are minimal, and the added complexity may not be worth the small performance benefits.

When comparing LSRRO and OARO performance, LSRRO tends to perform worse at high salinities due, at least in part, to the need for LSRRO systems to pass higher volumes of both salt and water through membranes to achieve the desired level of separation, with large volumes of water being recirculated in loops through pumps and membranes that have parasitic losses. Comparatively, however, LSRRO generally uses less membrane area, and achieves significantly higher water fluxes due, at least in part, to the avoidance of internal concentration polarization, which corresponds to a reduction in capital costs for LSRRO. OARO, on the other hand, passes significantly smaller volumes through the membranes, and recovers excess energy with ERDs or turbochargers. However, OARO can use approximately 30% less energy at high recovery ratios, thereby reducing the difference in energy consumption at these lower recovery ratios.

In some embodiments, the multi-stage systems can be optimized to reduce energy consumption by varying membrane parameters and flow rates. Testing indicates that OARO outperforms LSRRO at high recoveries, while the systems perform similarly at recoveries below 75% for seawater feed. LSRRO consistently requires less membrane area and achieves higher fluxes, but the advantage of high fluxes can be offset by the requirement to recirculate large fluid volumes. Ultimately, the choice between the two is dependent on required recovery ratio and relative costs of energy and capital equipment.

The trends in energy consumption and system size that were shown for single-stage systems largely carry over to multi-stage systems. Energy consumption is similar for single-stage systems at low salinities, but at higher recoveries, OARO systems are more efficient. LSRRO has a wider range of possible cost-optimal conditions, and can achieve significantly higher fluxes when optimized to minimize system size. Split-feed OARO systems have a limited operating range, while the other configurations can achieve higher recovery ratios.

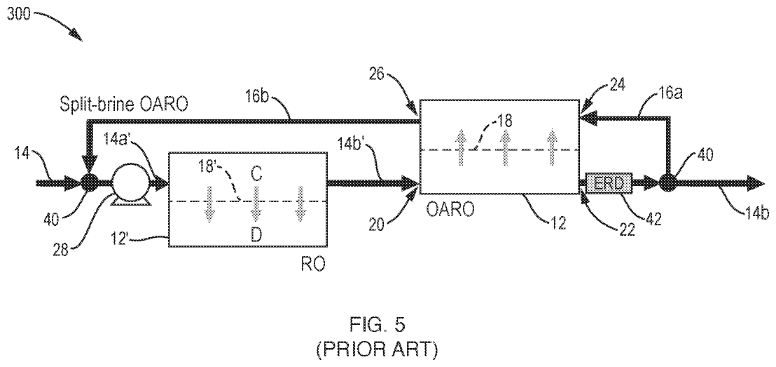

FIG. 5 illustrates a prior art example of a desalination system in a split-brine OARO configuration 300. In contrast to the split-feed OARO configurations 100, 200 discussed above, the split-brine configuration 300 is simpler, as only a single ERD 42 is used regardless of the of the number of stages, and there is no limit on the recovery ratio of a single stage. As shown, the concentrate product stream 14b in the split-brine OARO system 300 is split at the junction 40 after being passed through the ERD 42 such that the brine is recycled through the diluate inlet 24 via an inlet stream 16a through the diluate side D that then passes out of the diluate outlet 26 as a diluate stream to be added to the RO feed stream 14′. Thermodynamically, the system is inherently unbalanced, as the osmotic pressure at the concentrate outlet 22/diluate inlet 24 is equal on both sides of the membrane 18, and not equal at the concentrate inlet 20/diluate outlet 26 for all systems with nonzero recovery. As a result, the water flux will be unbalanced inside the system, and losses due to non-equipartitioning of entropy generation will be larger than in a split-feed configuration.

FIG. 5 provides insight into the difference in operation and performance for split-brine OARO by virtue of comparison to the split-feed OARO system 100 of FIG. 3A. The split-feed OARO system 100, as noted previously, has a limited recovery ratio, which is determined by the osmotic pressure of the OARO feed stream and the hydraulic pressure allowable in the membranes. The split-brine system 300 does not have this limitation, and achieves higher recovery ratios and has a higher operating range, but performs with a slightly lower efficiency and lower fluxes due to the poor thermodynamic balancing of the system, as discussed above.

### Semi-Split Oaro Configuration

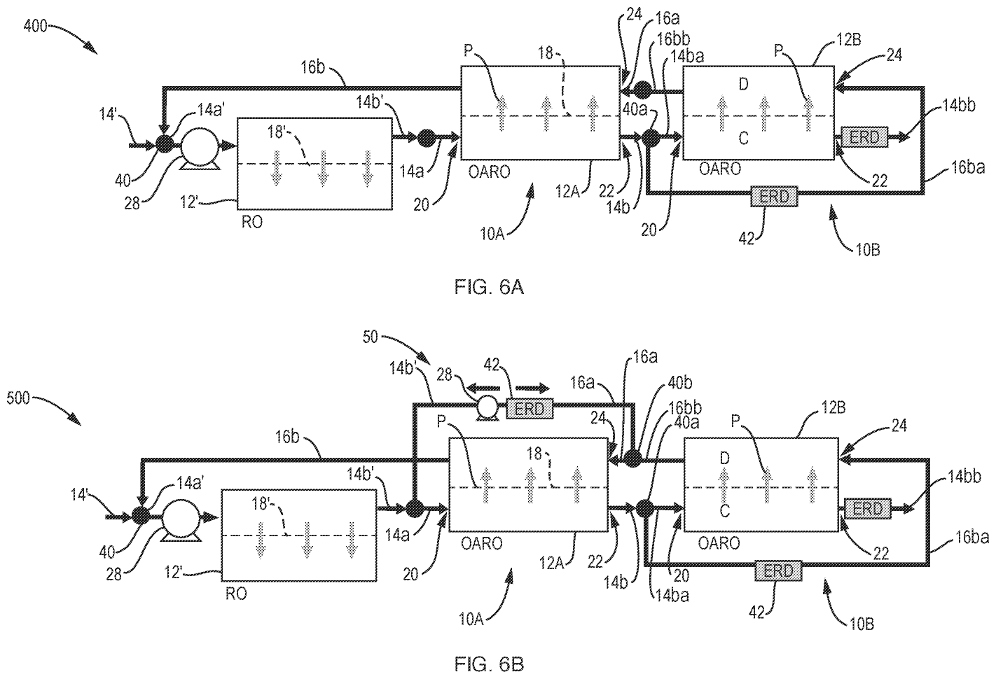

FIGS. 6A-6B illustrates an exemplary embodiment of a novel desalination system utilizing a semi-split OARO configuration 400, 500. The semi-split OARO configuration 400 can combine aspects of the split-feed system 200 and the split-brine system 300 while improving on both split-feed and split-brine OARO configurations discussed above by improving system complexity, energy consumption, and membrane usage compared to existing designs, e.g., reducing the number of pumps and energy recovery devices required to operate the system, while extending the operating range of standalone systems with minimal cost increases, if any. While the semi-split OARO configuration 400 is shown to include an RO unit 10′ in series with one or more OARO units 10, the semi-split OARO configuration 400 can achieve desired performance without being in fluid communication with an RO module 12′. Moreover, a person skilled in the art will recognize that while the embodiment of the semi-split OARO configuration 400 discussed herein includes fluid communication with the RO module 12′, inclusion of the RO module 12′ is merely exemplary and is not intended to limit the semi-split OARO configuration 400 to include the RO module 12′. Further, although a pair of OARO units 10A, 10B is shown and described in FIGS. 6A-6B, it will be appreciated that the semi-split OARO configuration 400 can utilize a single OARO unit 10 or three or more OARO units 10.

While the semi-split OARO configuration 400 can combine aspects of the split-feed system 200 and the split-brine system 300, as noted above, the transition from a split-brine system 300 to a semi-split OARO configuration 400 of the present embodiments is novel and yields unexpected results. For example, the semi-split OARO configuration 400 can utilize additional equipment, such as an additional ERD 42, as shown in FIG. 6A, to depressurize the concentrated product stream 14b. In some embodiments, the local flux at the concentrate outlet 22 may decrease in the semi-split OARO configuration 400, which may not be seen as beneficial by one skilled in the art, but is beneficial in the semi-split OARO configuration 400 of the present embodiments. For example, as will be appreciated by one skilled in the art, split-brine systems 300 can be used for their unlimited recovery ratios in single stage systems, which can be jeopardized by changing the configuration thereof, while split-feed systems, on the other hand, may be designed to maximize efficiency, with a change in the split-brine system being recognized as detrimental by one skilled in the art if operating efficiency is the driving factor for cost. The arrangement of the components of the semi-split OARO configuration 400 of the embodiments discussed herein can avoid these detrimental effects discussed above by working together and being optimized to improve the efficiency of the split-brine system and the range of the split feed system using the novel configurations of the present embodiments discussed herein.

As shown, the first and second OARO units 10A, 10B can include OARO modules 12A, 12B, respectively, which can receive a concentrate feed stream 14 through an inlet on a concentrate side C of the first OARO module 12A. As discussed above, the concentrate feed stream 14a can be an RO concentrate stream 14b′ when the OARO module 12A is in fluid communication with the RO module 12′, as shown, though in some embodiments, the concentrate feed stream 14a can be a liquid feed that includes saline water, oilfield brines, mine tailings, municipal wastewater, pulp and paper feedstocks, pharmaceuticals, and/or feed streams rich in valuable minerals, such as lithium. As noted above, fluid communication between modules includes the ability to flow fluid between the modules in ways mentioned above and/or those known to one skilled in the art. A concentrated product stream 14b can flow out of an outlet 22 of the module 12A after permeate P has been extracted therefrom, with the concentrated product stream 14b at the outlet 22 being more concentrated than the concentrate feed stream 14a at the inlet 20.

Unlike the split-feed OARO configurations 100, 200 in which the concentrate feed stream was split prior to passing through the inlet 20 of the OARO module 12A, the concentrate feed stream 14a can pass directly through the inlet 20 without being split. In some embodiments, a pump 28 can be used to pump the concentrate feed stream 14a into the first module 12A, though it will be appreciated that in some embodiments, e.g., small-scale configurations, the semi-split OARO configuration 400 can flow fluid using a single pump and/or without a pump. The concentrated product stream 14b leaving the first OARO module 12A can then split at junction 40a into a plurality of streams. As shown, a portion of the concentrated product stream 14b can form a concentrated product feed stream 14ba that can enter the concentrate side C of the second unit 10B, and a second portion of the concentrated product stream 14b can form a concentrated product diluate feed stream 16ba that can enter the diluate side D of the second OARO unit 10B through inlet 24. In some embodiments, the concentrated product stream 14b can be depressurized in an ERD 42 prior to entering the diluate side D of the second OARO unit 10B as the concentrated product diluate feed stream 16ba. A diluate product 16bb can be formed in the OARO module after receiving the permeate P therein via the membrane 18, e.g., a hollow fiber membrane, which can then enter the diluate side D of the first OARO module 12A as diluate-side feed stream 16a. Moreover, a diluate 16b can form in the first OARO module 12A after receiving the permeate P therein that can exit via the outlet 24 to be mixed with the RO feed stream 14′. The product stream 14bb leaving the concentrate side C of the second OARO module 12B can flow through an ERD 42 before exiting the system 400. It will be appreciated that in some embodiments, a single ERD 42 can be used for the depressurization of streams throughout the semi-split OARO configuration 400 in an effort to reduce system size and/or costs, or in systems which do not include a pump, for example. The product stream 14bb can have a salinity that is substantially greater than the concentrate feed stream 14 introduced into the system 400.

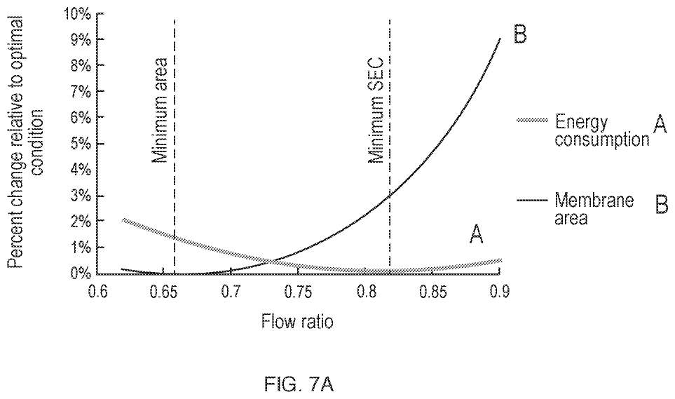

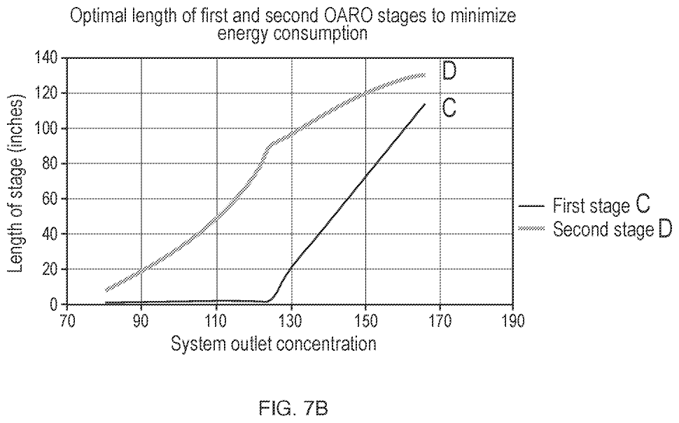

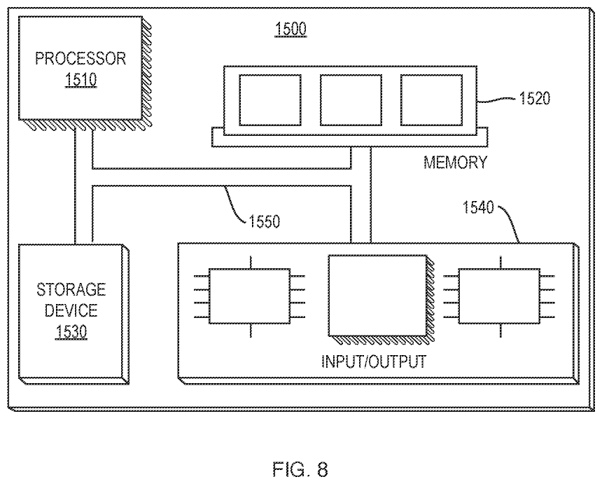

The semi-split OARO configuration 400 has a number of benefits. First, like split-brine OARO, there is hypothetically an unlimited maximum concentration that can be reached, although practical considerations can impose limitations. Moreover, the semi-split OARO configuration 400 design can have the potential to be better thermodynamically balanced than the split-brine configuration 300, as the osmotic pressure difference across the membrane at the concentrate discharge point is non-zero. In the split-brine system 300, for example, the salinity of the diluate-side feed stream 16 is fixed at the same salinity as the concentrate-side outlet 22, and only the mass flow rate of at the diluate side inlet 24 is variable. In the semi-split OARO configuration 400 of the present embodiments, on the other hand, both the flow rate and salinity at the diluate side inlet 24 or the concentrate side inlet 20 are free variables that can be changed by adjusting one or more of the relative lengths of the two OARO stages 10A, 10B, or the fraction of the flow separated at the inter-stage split point 40a. That is, in the most basic configuration of the semi-split OARO system 400, there can be two variables to optimize when the outlet salinity is fixed: salinity at the concentrate outlet 22 of the first OARO stage 10A; and the mass fraction of the concentrate outlet 22 of the first OARO stage 10A that enters the concentrate inlet of the second OARO stage 10B. A discussion of some examples of optimizations can be found below with respect to FIGS. 7A and 7B. Moreover, the semi-split configuration can also operate with fewer turbomachinery components than the previously-disclosed split-feed configurations 100, 200. It will be appreciated that in the limit where the salinity between the two OARO stages 10A, 10B approaches the salinity of the outlet 22 of the second stage 10B, performance and operation of the semi-split OARO configuration 400 can approach the operation of a one-stage split-brine system 300. In the opposite limit, as the inter-stage concentration approaches the RO concentration of brine, the split-brine portion of the semi-split OARO configuration 400 becomes very small, and system performance and operation approaches that of a split-feed system. Therefore, optimizing this system provides insight into the tradeoffs between feed-split and brine-split OARO systems.

As noted above, at low concentrations, the multi-stage operation of the semi-split OARO configuration 400 can mirror that of a split-feed system, in which the inter-stage salinity can be selected such that the split-feed system does the maximum possible thermodynamic work. At high concentrations, optimizations produce the same result, maximizing the work done by the split-feed portion of the system, with the split-brine portion extending the operating range. Moreover, a further comparison of the semi-split OARO configuration 400 with the split-feed 100, 200 and the split-brine systems 300 can show that the more balanced flux of the split-feed system can lead to reduced losses due to concentration polarization and nonequipartitioning losses, which reduces energy consumption. Moreover, the semi-split system 400 of the present embodiments may offer a useful compromise in practice, allowing for more balanced operation, especially at very high concentrations, with fewer pieces of equipment and a larger operating range than a true split-feed system.

Due to the additional operational flexibility provided by having a second split point 40b in the semi-split OARO system 400, a greater range of possible operating conditions may be possible. Due to this flexibility, for example, semi-split OARO configurations 400 can likely be configured to outperform single-stage split-feed OARO 100 and split-brine OARO systems 300 in terms of levelized cost of water. Additionally, semi-split OARO systems 400 can outperform two-stage OARO systems 200 under lower recovery conditions as the very minor improvements in flux at high salinities are likely offset by the lower number of pumps and ERDs, simpler control systems, and/or simpler design of semi-split OARO configurations 400.

The semi-split OARO configuration 400 can combine the advantages of the operating range and simplicity of brine-splitting OARO and the thermodynamic balancing and energy efficiency of split-feed OARO. Moreover, when optimized for specific energy consumption (units of kWh/m³), the semi-split OARO configuration 400 can essentially perform like the OARO split-feed system 100 at low recovery ratios, with the split-feed second stage doing the bulk of the concentration work, and the first stage becoming as small as possible. As the recovery ratio increases, eventually the concentration limit of a single split-feed stage can be reached, and the first stage 10A can begin to perform additional useful separation work. Optimization of the semi-split OARO configuration 400 of the present embodiments can lead to one of several intermediate goals, such as minimizing pump work, reducing pressure losses, thermodynamically balancing concentrations, increasing fluxes, or reducing membrane area, among others. It will be appreciated that these intermediate goals may be in service of a larger goal, such as minimizing total costs and/or or operating/capital costs of the system, e.g., maximizing energy efficiency or minimize energy consumption or cost.

FIG. 6B illustrates one example of a semi-split OARO configuration 500 having a rebalance stream 50. As shown, the rebalance stream 50 can be an additional stream that can modify the semi-split OARO configuration 400 to connect the RO outlet stream 14b′ to the split point 40b located between the diluate inlet 24 of the first OARO stage 10A diluate entrance and the diluate outlet 26 of the second OARO stage 10B. The rebalance stream 50 can flow in either direction, as shown, to flow contents of the RO outlet stream 14b′ and the diluate product 16a contents therebetween to balance the salinities and flow rates around the first OARO unit 10A. An additional pump 28 and/or an ERD 42 can be used to enable the balancing of hydraulic pressures, e.g., to pressurize the rebalance stream 50 to a higher pressure, though in some embodiments, an additional pump 28, an additional ERD 42, or both, are not included. The potential benefits of thermodynamic rebalancing can be counteracted by the parasitic losses of inefficient pumps and ERDs.

A number of variables of the semi-split OARO configuration 400 of the present embodiments can be optimized. FIGS. 7A-7B illustrate some non-limiting examples of optimization of variables of the semi-split OARO configuration 400 in greater detail. For example, FIG. 7A illustrates how changing the flow ratio can affect a total membrane area (curve B) in the semi-split OARO configuration 400, as well as the specific energy consumption (SEC) (units of kWh/m³ of pure water) (curve A) in a case in which salt water (NaCl) is concentrated to a 100 g/kg concentration. The flow ratio for FIG. 7A can be defined as the fraction of flow that goes to the concentrate inlet 20, e.g., flow through the concentrate inlet 20 divided by the flow through the concentrate outlet 22. As shown, as the flow ratio increases between minimum area and minimum specific energy consumption, the percent change relative to optimal condition for energy consumption (curve A) can decrease, with a gradual increase in the percent change being observed for flow ratios of 0.9. Moreover, membrane area (curve B) can increase over the same range, with continuing increases observed for flow ratios beyond the minimum specific energy consumption.

FIG. 7B illustrates optimal lengths of first and second OARO units 10A, 10B to minimize energy consumption of the first unit 10A (curve C) and the second unit 10B (curve D) at various concentrations for an example in which the semi-split OARO configuration 400 is concentrating from 35 g/kg into the RO system up to a range of concentrations, e.g., approximately 170 g/kg, at the concentrate outlet 22. As shown, for a given value of outlet concentration, e.g., concentrations of approximately 80 g/kg to approximately 170 g/kg, a length of the second stage 10B (curve D) can be higher than a length of the first stage 10A (curve C) to minimize energy consumption. In such an embodiment, a length of the first stage 10A can remain constant from a concentration of approximately 80 g/kg up until a concentration of approximately 125 g/kg, while a length of the second stage 10B shows a gradual increase throughout that range.

In some embodiments, the systems of the present embodiments 400, 500 can be coupled and/or otherwise associated with a controller configured to move the first and second fluid paths between concentrate streams and diluate streams, such configurations being understood in view of the present disclosures. FIG. 8 is a block diagram of one exemplary embodiment of a computer system 1500 upon which the controller or control system of the present disclosures can be built, performed, trained, etc. For example, any units, stages, modules, or systems can be examples of the system 1500 described herein. The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500. The processor 1510 can be a single-threaded processor, a multi-threaded processor, or similar device. The processor 1510 can be capable of processing instructions stored in the memory 1520 or on the storage device 1530. The processor 1510 may execute operations such as, by way of non-limiting examples, starting and stopping flow of fluid, control of fluid paths and system configurations that can be automatic, in response to various parameters, and/or manually controlled by a user, including in response to signals/parameters/etc., and so forth, and/or based on observation/preference, and so forth, among other features described in conjunction with the present disclosure. The controller 1500 can optimize operation in response to varying feedwater conditions, varying water demand, varying power pricing, and other factors that can relate to the energy efficiency, reliability, maintenance, or levelized cost of freshwater. In some instances, the controller 1500 can optimize operation in response to feedwater flow rates, concentrations, permeate salinity, and/or operating pressures, among others. The controller 1500 may further embed machine-learning techniques, artificial intelligence, and/or digital twinning that can aid in improving performance.

The memory 1520 can store information within the system 1500. In some implementations, the memory 1520 can be a computer-readable medium. The memory 1520 can, for example, be a volatile memory unit or a non-volatile memory unit. In some implementations, the memory 1520 can store information related to product and diluate streams, numbers of stages, and so forth.

The storage device 1530 can be capable of providing mass storage for the system 1500. In some implementations, the storage device 1530 can be a non-transitory computer-readable medium. The storage device 1530 can include, for example, a hard disk device, an optical disk device, a solid-date drive, a flash drive, magnetic tape, and/or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card or an InfiniBand interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1540 can include driver devices configured to receive input data and send output data to other input/output devices, e.g., a keyboard, a printer, and/or display devices. In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and/or input/output devices 1540.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a fluid filtration system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), in an object-oriented programming language (e.g., “C++”), and/or other programming languages (e.g. Java, JavaScript, PHP, Python, and/or SQL). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

Examples of the above-described embodiments can include the following:

1. A desalination system, comprising:
a first osmotically assisted reverse osmosis (OARO) unit having a concentrate side with a first inlet and a first outlet and a diluate side with a second inlet and a second outlet;
a second OARO unit in fluid communication with the first OARO unit, the second OARO unit having a concentrate side with a first inlet and a first outlet and a diluate side with a second inlet and a second outlet; and
a liquid feed received in the first inlet of the first OARO unit,
wherein a concentrated stream leaving the first OARO unit is split into a first stream and a second stream, with the first stream entering the first inlet of the second OARO unit and the second stream being depressurized and entering the second inlet of the second OARO unit,
wherein a diluate product of the second OARO unit enters the second inlet of the first OARO unit, and
wherein a concentrate product exiting the first outlet of the second OARO unit is depressurized and includes an outlet stream having a salinity that is greater than a salinity of the liquid feed.

2. The desalination system of claim 1, wherein the diluate product of the second OARO unit is split into a first diluate stream and a second diluate stream, with the first diluate stream entering the second inlet of the first OARO unit and the second diluate stream being pressurized and entering the concentrate side of the first OARO unit.

3. The desalination system of claim 1 or claim 2, wherein a relative length of the first OARO unit and a relative length of the second OARO unit are configured to be adjusted to optimize at least one of a flow rate or salinity at the first inlet of the second OARO unit and the second inlet of the second OARO unit to minimize energy consumption.

4. The desalination system of any of claims 1 to 3, wherein a fraction of flow split between the first stream and second stream is configured to be adjusted to optimize at least one of a flow rate or salinity at the first inlet of the second OARO unit and the second inlet of the second OARO unit to minimize energy consumption or total membrane area.

5. The desalination system of any of claims 1 to 4, wherein the salinity of the first outlet of the first OARO unit is configured to be optimized when the salinity at the first outlet of the first OARO unit is fixed to minimize energy consumption.

6. The desalination system of any of claims 1 to 5, wherein a fraction of the concentrate of the first OARO unit entering the first inlet of the second OARO unit is configured to be optimized when the salinity at the first outlet of the first OARO unit is fixed to minimize energy consumption or total membrane area.

7. The desalination system of any of claims 1 to 6, wherein at least one of the first and second OARO units further comprises one or more hollow fiber membranes.

8. The desalination system of any of claims 1 to 7, wherein at least a portion of the diluate product of the second OARO unit is mixed with the liquid feed prior to passing through the first inlet of the first OARO unit.

9 The desalination system of any of claims 1 to 8, wherein the first OARO unit and the second OARO unit are arranged in series.

10. The desalination system of any of claims 1 to 9, further comprising a reverse osmosis (RO) unit in fluid communication with the first OARO unit, the RO unit having a first inlet and a first outlet.

11. The desalination system of claim 10, wherein the liquid feed is an RO concentrate stream passed through the RO prior to passing into the first inlet.

12. The desalination system of claim 10 or claim 11, wherein the diluate product of the first OARO unit is mixed with a feed that passes through the first inlet of the RO unit to form the RO concentrate stream.

13. The desalination system of any of claims 10 to 12, wherein the first OARO unit and the second OARO unit are arranged in series with the RO unit.

14. The desalination system of any of claims 1 to 13, further comprising one or more energy recovery devices (ERDs) configured to depressurize one or more of the second stream or the concentrate product.

15. A method of desalinating fluid, comprising:
flowing a liquid feed through a first osmotically assisted reverse osmosis (OARO) unit having a concentrate side with a first inlet and a first outlet and a diluate side with a second inlet and a second outlet, and a second OARO unit arranged in series with the first OARO unit, the second OARO unit having a concentrate side with a first inlet and a first outlet and a diluate side with a second inlet and a second outlet;
splitting a concentrated stream leaving the first OARO unit into a first stream and a second stream, with the first stream entering the first inlet of the second OARO unit and the second stream being depressurized and entering the second inlet of the second OARO unit;
flowing a diluate product of the second OARO unit through the second inlet of the first OARO unit; and
depressurizing a concentrate product exiting the first outlet of the second OARO unit, a salinity of the concentrate product being greater than a salinity of the liquid feed.

16. The method of claim 15, further comprising:

splitting the diluate product of the second OARO unit into a first diluate stream and a second diluate stream, the first diluate stream entering the second inlet of the first OARO unit and the second diluate stream being pressurized and entering the concentrate side of the first OARO unit.

17. The method of claim 15 or claim 16, further comprising:
adjusting a relative length of the first OARO unit and a relative length of the second OARO to optimize at least one of a flow rate or salinity at the first inlet of the second OARO unit and the second inlet of the second OARO unit to minimize energy consumption or total membrane area.

18. The method of any of claims 15 to 17, further comprising:
adjusting a fraction of flow split between the first stream and second stream to optimize at least one of a flow rate or salinity at the first inlet of the second OARO unit and the second inlet of the second OARO unit to minimize energy consumption or total membrane area.

19. The method of any of claims 15 to 18, further comprising:
mixing the diluate product of the second OARO with the liquid feed prior to flowing the liquid feed through the first inlet of the first OARO unit.

20. The method of any of claims 15 to 19, further comprising:
pumping a liquid feed into an inlet of an RO unit that is in fluid communication with the first OARO unit to form a product concentrate stream that is fed into the inlet of the first OARO unit.

21. The method of any of claims 15 to 20, further comprising:
operating one or more ERDs to depressurize one or more of the second stream or the concentrate product.

One skilled in the art will appreciate further features and advantages of the disclosures based on the provided for descriptions and embodiments. Accordingly, the inventions are not to be limited by what has been particularly shown and described. All publications and references cited herein are expressly incorporated herein by reference in their entirety.

Some non-limiting claims that are supported by the contents of the present disclosure are provided below.

1. A desalination system, comprising:
a first osmotically assisted reverse osmosis (OARO) unit having a concentrate side with a first inlet and a first outlet and a diluate side with a second inlet and a second outlet;
a second OARO unit in fluid communication with the first OARO unit, the second OARO unit having a concentrate side with a first inlet and a first outlet and a diluate side with a second inlet and a second outlet; and
a liquid feed received in the first inlet of the first OARO unit,
wherein a concentrated stream leaving the first OARO unit is split into a first stream and a second stream, with the first stream entering the first inlet of the second OARO unit and the second stream being depressurized and entering the second inlet of the second OARO unit,
wherein a diluate product of the second OARO unit enters the second inlet of the first OARO unit, and
wherein a concentrate product exiting the first outlet of the second OARO unit is depressurized and includes an outlet stream having a salinity that is greater than a salinity of the liquid feed.

2. The desalination system of claim 1, wherein the diluate product of the second OARO unit is split into a first diluate stream and a second diluate stream, with the first diluate stream entering the second inlet of the first OARO unit and the second diluate stream being pressurized and entering the concentrate side of the first OARO unit.

3. The desalination system of claim 1, wherein a relative length of the first OARO unit and a relative length of the second OARO unit are configured to be adjusted to optimize at least one of a flow rate or salinity at the first inlet of the second OARO unit and the second inlet of the second OARO unit to minimize energy consumption.

4. The desalination system of claim 1, wherein a fraction of flow split between the first stream and second stream is configured to be adjusted to optimize at least one of a flow rate or salinity at the first inlet of the second OARO unit and the second inlet of the second OARO unit to minimize energy consumption or total membrane area.

5. The desalination system of claim 1, wherein the salinity of the first outlet of the first OARO unit is configured to be optimized when the salinity at the first outlet of the first OARO unit is fixed to minimize energy consumption.

6. The desalination system of claim 1, wherein a fraction of the concentrate of the first OARO unit entering the first inlet of the second OARO unit is configured to be optimized when the salinity at the first outlet of the first OARO unit is fixed to minimize energy consumption or total membrane area.

7. The desalination system of claim 1, wherein at least a portion of the diluate product of the second OARO unit is mixed with the liquid feed prior to passing through the first inlet of the first OARO unit.

8. The desalination system of claim 1, wherein the first OARO unit and the second OARO unit are arranged in series.

9. The desalination system of claim 1, further comprising a reverse osmosis (RO) unit in fluid communication with the first OARO unit, the RO unit having a first inlet and a first outlet.

10. The desalination system of claim 9, wherein the liquid feed is an RO concentrate stream passed through the RO prior to passing into the first inlet.

11. The desalination system of claim 9, wherein the diluate product of the first OARO unit is mixed with a feed that passes through the first inlet of the RO unit to form the RO concentrate stream.

12. The desalination system of claim 9, wherein the first OARO unit and the second OARO unit are arranged in series with the RO unit.

13. The desalination system of claim 1, further comprising one or more energy recovery devices (ERDs) configured to depressurize one or more of the second stream or the concentrate product.

14. A method of desalinating fluid, comprising:
flowing a liquid feed through a first osmotically assisted reverse osmosis (OARO) unit having a concentrate side with a first inlet and a first outlet and a diluate side with a second inlet and a second outlet, and a second OARO unit arranged in series with the first OARO unit, the second OARO unit having a concentrate side with a first inlet and a first outlet and a diluate side with a second inlet and a second outlet;
splitting a concentrated stream leaving the first OARO unit into a first stream and a second stream, with the first stream entering the first inlet of the second OARO unit and the second stream being depressurized and entering the second inlet of the second OARO unit;
flowing a diluate product of the second OARO unit through the second inlet of the first OARO unit; and
depressurizing a concentrate product exiting the first outlet of the second OARO unit, a salinity of the concentrate product being greater than a salinity of the liquid feed.

15. The method of claim 14, further comprising:
splitting the diluate product of the second OARO unit into a first diluate stream and a second diluate stream, the first diluate stream entering the second inlet of the first OARO unit and the second diluate stream being pressurized and entering the concentrate side of the first OARO unit.

16. The method of claim 14, further comprising:
adjusting a relative length of the first OARO unit and a relative length of the second OARO to optimize at least one of a flow rate or salinity at the first inlet of the second OARO unit and the second inlet of the second OARO unit to minimize energy consumption or total membrane area.

17. The method of claim 14, further comprising:
adjusting a fraction of flow split between the first stream and second stream to optimize at least one of a flow rate or salinity at the first inlet of the second OARO unit and the second inlet of the second OARO unit to minimize energy consumption or total membrane area.

18. The method of claim 14, further comprising:
mixing the diluate product of the second OARO with the liquid feed prior to flowing the liquid feed through the first inlet of the first OARO unit.

19. The method of claim 14, further comprising:
pumping a liquid feed into an inlet of an RO unit that is in fluid communication with the first OARO unit to form a product concentrate stream that is fed into the inlet of the first OARO unit.

20. The method of claim 14, further comprising:
operating one or more ERDs to depressurize one or more of the second stream or the concentrate product.
